(19) United States
(12) Patent Application Publication
(10) Pub. No.: US 2023/0334462 A1
(43) Pub. Date: Oct. 19, 2023

(54) METHODS AND SYSTEMS OF MOBILE PAYMENT AND VOUCHER REDEMPTION

(71) Applicants: Kelly Lu Chen, Plano, TX (US); Bilin Chen, Plano, TX (US)

(72) Inventors: Kelly Lu Chen, Plano, TX (US); Bilin Chen, Plano, TX (US)

(21) Appl. No.: 18/155,753

(22) Filed: Jan. 18, 2023

Related U.S. Application Data
(63) Continuation-in-part of application No. 17/855,956, filed on Jul. 1, 2022.
(60) Provisional application No. 63/217,432, filed on Jul. 1, 2021.
(60) Provisional application No. 63/310,813, filed on Feb. 16, 2022.

(51) Int. Cl. G06Q 20/32; G06Q 20/02; G06Q 30/04; G06Q 20/34

(52) U.S. Cl. CPC G06Q 20/3223; G06Q 20/027; G06Q 30/04; G06Q 20/3274; G06Q 20/342

(57) ABSTRACT

The present invention generally relates to systems and methods for executing in-store payments using a third-party mobile wallet. More specifically, the present invention relates to systems and methods for executing in-store mobile payment with voucher redemption automatically and in sequence.

### CROSS-REFERENCE TO RELATED APPLICATIONS

The present application is a continuation-in-part of and claims the benefit of priority from U.S. application Ser. No. 17/855,956, Jul. 1, 2022, which is incorporated herein by reference in its entirety and which claims the benefit of priority from U.S. Provisional Application No. 63/217,432, entitled “Methods and Systems of Mobile Payment with Coupon Redemption”, filed on Jul. 1, 2021, which is incorporated herein by reference in its entirety; the application is also based on, and claims the benefit of priority from U.S. Provisional Patent Application Ser. No. 63/310,813, filed on Feb. 16, 2022, which is also incorporated herein by reference in its entirety.

### TECHNICAL FIELD

The present invention generally relates to systems and methods for executing in-store payments using a third-party mobile wallet. More specifically, the present invention relates to systems and methods for executing in-store mobile payments with voucher redemptions automatically and in sequence.

### BACKGROUND OF THE INVENTION

Coupons and vouchers have been around for years both in print and electronic forms. They are among the good and effective ways of business promotions. Some coupons are limitedly used to get discounts on certain products, e.g., manufacturer coupons. Some coupons are not defined to use on specific products, but bear some defined cash values that the holder can redeem as cash on any item. The latter form of coupon is defined as a voucher in this application.

Normally, the merchants redeem vouchers and take the payments separately and manually at the registers. The inefficacy will slow down the checking process. Mobile wallet apps like Google Pay and Apple Wallet are increasingly popular, but they cannot handle in-store payments and voucher redemptions simultaneously.

Even though some popular apps have the potential to become mobile wallets, the threshold of adopting near-field communication (NFC), the same technology as Apple Wallet and Google Pay are using, is relatively high. Using QR codes representing payment tokens is a good alternative for those who want to become mobile wallets. The payment token is one of the secure ways to track and transfer payment account information (such as credit card and debit card information).

Some popular mobile coupon apps, such as Groupon, are utilized to show the vouchers on the phones to in-store cashiers. However, these apps cannot be used as mobile wallets under the current payment technology and infrastructure. Customers have to use different ways to pay for the balances after discounts.

A payment gateway used to be a merchant service provided by an e-commerce application service provider that authorizes credit card or debit card payment processing for e-businesses and online retailers. But after the POS (point of sales) systems of brick-and-mortar merchants were connected to the internet, the merchants could collect money using payment gateways for their offline businesses. Payment service companies such as Square and Clover make in-store payments through their payment gateways. While a typical payment gateway facilitates a payment transaction by transferring information between a payment portal (such as a website or POS) and a front-end processor or acquiring bank, the payment account information, including credit card or debit card information, is the only information which can be transferred to the payment gateways from the payment portals. If a third-party mobile wallet (independent of merchants and payment gateways) wants to use payment tokens to represent credit card information, there will be no way for the payment gateway to verify the payment token due to the lack of passage to the mobile wallet system.

Also, for security reasons, the merchants' POS systems are usually not allowed to connect with other third-party systems except the payment gateways.

In summary, even if a third-party mobile wallet finds a way to transfer payment tokens to merchants' POS systems, there is no way for them to get the payment token verification request from the payment gateway. The current payment gateway infrastructure limits the development and application of third-party mobile wallets.

Therefore, there is a need for some new systems and methods that can execute in-store mobile payment and voucher redemption at the same time. The third-party mobile wallets also need new infrastructures to get on the road. Correspondingly, payment gateways should also add some new architectures (features and functionalities) to help accomplish voucher redemption and payment automatically and in sequence. Simple and easy third-party IT solutions are needed to promote business, especially for some small merchants which have low budgets to upgrade their POS systems.

### SUMMARY OF THE INVENTION

The problems cited in the background are solved by the present invention.

The inventive arrangement combines mobile payments and digital voucher redemptions by showing only one QR code on customers' cell phones. The voucher redemptions usually are accomplished in merchants' POS (Point of Sale) systems, but some merchants' POS systems don't have the functions that the merchants are not willing to add so as not to bloat and complicate their systems. To solve the problems, the present invention redeems vouchers in the online payment gateway system, which also processes the payments of transactions.

By scanning a QR code shown on the customers' cell phones, the POS system can get a payment token, then the voucher redemption and payment will be executed automatically and in sequence by the inventive methods and systems.

Comprehensively, the invention can also bring the below benefits to merchants, consumers, and proprietors of some mobile apps:

1. The voucher redemption is automatically accomplished by the systems; 2. The systems and methods can be used by retail stores and restaurants; 3. Any mobile app with a payment account can be used as a mobile wallet, i.e., the apps of Amazon, Walmart, Chase, Groupon, etc., can be used for payment at any merchants' registers that adopt the inventive methods and systems, with or without redeeming a voucher; 4. The merchants' POS (Point of Sale) systems and Sales Invoicing Management Servers are still safely separated from the outside information systems. The information exchange with the outside servers is strictly limited. The private business data, including transaction information, are as well-kept as the security of the POS system; 5. Gift card redemptions can also be fulfilled in payment gateway systems by using the inventive methods and systems.

The inventive systems mainly include three units: 1. Payment Account System, including Mobile Phone and Payment Account Management Server (PAMS). The PAMS can be owned and managed by some financial organizations, merchants, and e-commerce companies, such as Groupon, Chase, Amazon, and Walmart; 2. Merchant Invoicing System, including POS terminal and Sales Invoicing Management Server (SIMS), which can be owned and managed by some merchants. For some small businesses, the POS terminal can be a cell phone with some relative app installed; 3. Payment Gateway System, which is managed by an online payment service provider. A payment token management module and a voucher redemption management module are added to the innovative payment gateway system. The three units may be owned and managed by different entities. A payment account system is defined as a third-party one when it is owned and managed by an entity independent of those owning and managing the merchant invoicing system and payment gateway system. Each of the three units may be divided into some subsystems. All of the units work together through the relative software.

Before using the arrangement, the consumer needs to have a registered payment account saved in some PAMS and, more specifically, have a mobile app relative to the PAMS to initiate the payment and voucher redemptions.

To initiate the payment, the consumer uses the mobile app to produce a QR code, which includes the payment token (session ID). The QR code is scanned into the POS terminal and SIMS during checkout, not necessarily after the bill is produced. If the voucher is going to be redeemed with the payment, the consumer also needs to add the voucher information to the payment account before launching the mobile phone payment and voucher redemption.

The QR code is actually an imaged data packet. The data packet can also be transmitted from the payment account system to the merchant invoicing system by a wireless signal, such as NFC (near-field communication).

The SIMS sends the payment token and bill balance to the payment gateway system, where the payment token is used to identify which PAMS it is issued by. Then the payment token is transferred to the relevant PAMS.

According to the unique payment token, the PAMS matches and finds the initiating payment account, then sends the voucher information, if any, and the detailed payment account information, such as credit card information, to the payment gateway system. In some cases, the credit card information can be replaced by another token authorized by a Token Service Provider (TSP). This token differs from the payment token produced and authorized by a PAMS.

After getting the payment account and voucher information, the payment gateway system redeems the voucher first. It deducts the cash value of the voucher from the bill balance, then processes the payment of the rest of the bill using other payment methods, such as credit cards. If no voucher information comes with the payment account information, the payment gateway system will directly process the payment of the full bill balance.

Finally, the payment gateway sends the payment completion notice to the SIMS and PAMS.

The above-mentioned vouchers can also be gift cards. The gift card redemptions will similarly be processed in the payment gateway system.

By utilizing the inventive arrangement, the consumer can use some mobile apps, such as Chase, Groupon, Amazon, and Walmart apps, to pay at any merchants' registers that adopt the inventive systems and methods with or without redeeming vouchers. The inventive architecture can be used for third-party (independent of merchants and payment gateways) mobile payments with or without voucher redemptions.

Adopting the invention, merchants don't need to bloat and complicate their POS systems to fulfill the vouchers' redemption.

The digital voucher in this invention can be a unique string of letters and/or numbers. It can also be a standard-formatted description of voucher contents. In some cases, the vouchers are also mentioned as coupons or gift cards.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The detailed description of the illustrative embodiments can be read in conjunction with the accompanying figures. For simplicity and clarity of illustration, elements illustrated in the figures have not necessarily been drawn to scale.

A clear conception of the advantages and features constituting the present invention, and of the construction and operation of typical mechanisms provided with the present invention, will become more readily apparent by referring to the exemplary, and therefore non-limiting, embodiments illustrated in the drawing accompanying and forming a part of this specification, wherein like reference numerals designate the same elements in the several views, and in which:

FIG. 1 illustrates a functional block diagram depicting systems of voucher redemption and payment configured pursuant to some embodiments.

FIG. 2 illustrates an integrated block flowchart depicting the voucher redemption and payment process pursuant to some embodiments.

FIG. 3 illustrates a functional block diagram depicting a payment gateway system configured pursuant to some embodiments.

FIG. 4 illustrates some flow diagrams of some sample user interfaces associated with embodiments of the present invention.

### DETAILED DESCRIPTION OF PREFERRED EMBODIMENTS

A description of embodiments of the present invention will now be given with reference to the figures. It is expected that the present invention may be embodied in other specific forms without departing from its spirit or essential characteristics. The described embodiments are to be considered in all respects only as illustrative and not restrictive.

In describing the preferred embodiment of the invention, which is illustrated in the drawings, specific terminology will be resorted to for the sake of clarity. However, it is not intended that the invention be limited to the specific terms so selected, and it is to be understood that each specific term includes all technical equivalents that operate in a similar manner to accomplish a similar purpose.

The systems disclosed herein are used for implementing the methods for performing payment transactions and voucher redemptions. The systems may be a part of an application environment or ecosystem and be designed to perform their intended functions by communicating and interacting with other units and components thereof The operation of the systems is made possible by integrating hardware, software, and electronic communications. Herein, a “unit”, “module”, or “component” is a device, tool, machine, or software program designed to perform a particular task or function.

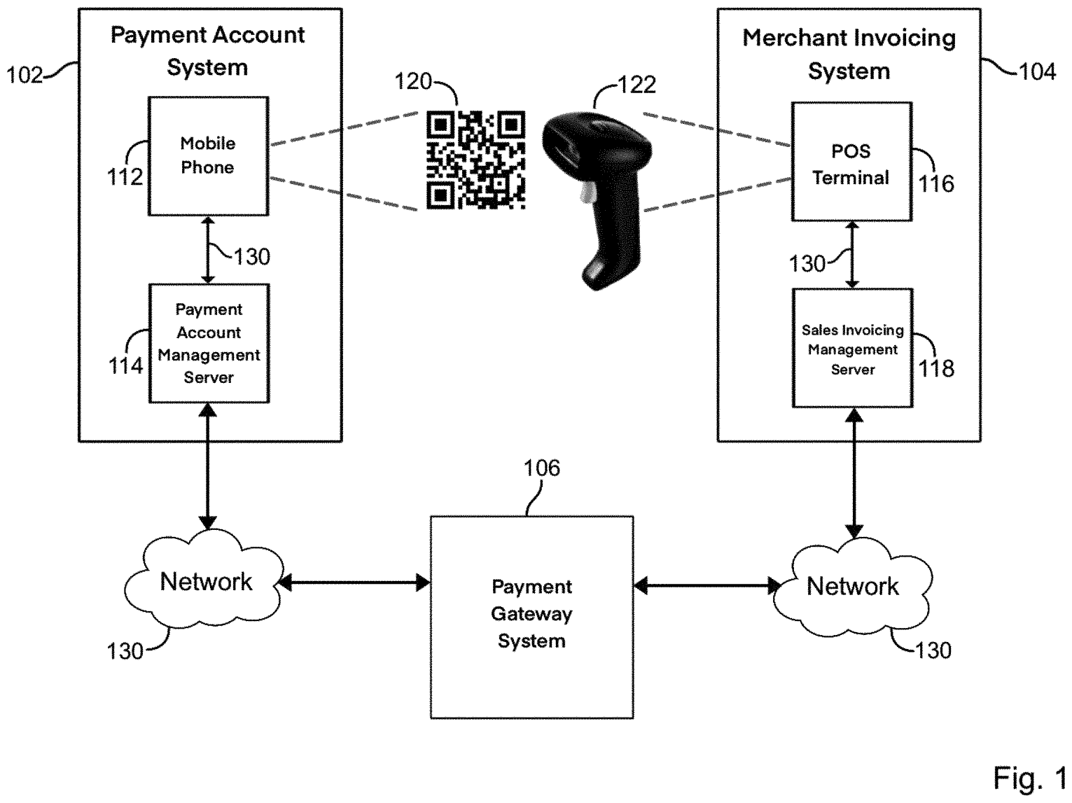

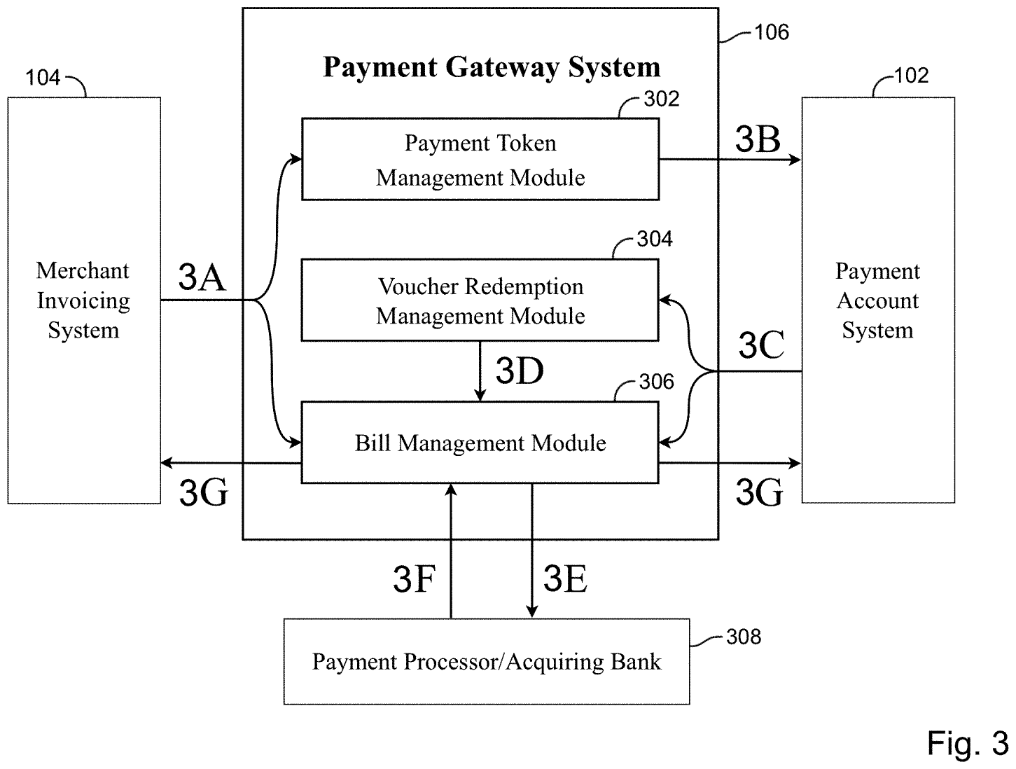

FIG. 1 shows a functional block diagram depicting a system of mobile payments with or without voucher redemptions. The inventive systems mainly include three units: 1. Payment Account System 102, including Mobile Phone 112 and Payment Account Management Server (PAMS) 114. The PAMS 114 can be owned and managed by some e-commerce companies, financial organizations, and merchants, such as Groupon, Chase, Amazon, and Walmart. If a payer or customer uses Amazon or Walmart websites or mobile apps to buy something, his payment account information, such as credit card or debit card information, may have been saved in the PAMS 114. Even though the mobile phone 112 used in the system belongs to payers or customers, there should be a mobile app which is developed by the e-commerce company, financial organization, or merchant installed in the mobile phone 112. The mobile app communicates with PAMS 114 by a network 130, e.g., such as the Internet or other public or private network which can be wired and/or wireless; 2. Merchant Invoicing System 104, including POS terminal 116 and Sales Invoicing Management Server (SIMS) 118, which can be owned and managed by merchants POS terminals 116 are located in the stores, preparing invoices for the customer. The SIMS 118 may be remotely arranged. POS terminals 116 can be connected with SIMS 118 by a network 130. The transaction information is collected at the POS terminal 116 and stored and managed in SIMS 118; 3. Payment Gateway System 106, which is managed by an online payment service provider; Payment Gateway System 106 communicates with the merchant invoicing system 104 and the payment account system 102 through networks 130. Payment token management modules 302 and voucher redemption management modules 304 are added to the innovative payment gateway system 106, which is depicted in FIG. 3 in more detail. The three units may be owned and managed by different entities. Each of the three units may be divided into some subsystems. All of the units work together through the relative software.

FIG. 1 also shows no direct network connection between payment account systems 102 and merchant invoicing systems 104. Due to security reasons, they restrict the information exchanges with other systems, while both of them have internet connections with payment gateway systems 106, usually under PCI (Payment Card Industry) compliance. PCI compliance refers to the technical and operational standards that businesses follow to secure and protect credit card data provided by cardholders and transmitted through card processing transactions. PCI standards for compliance are developed and managed by the PCI Security Standards Council.

FIG. 1 also shows that the merchant invoicing system 104 can get some specific information from the payment account system 102 by scanning a QR code 120 displayed on the customer's mobile phone 112. The scanner 122 is connected to the POS terminal 116 and only allows specifically formatted information to be scanned into the POS system. So, the data input from the scanner 122 won't endanger the merchant invoicing system 104.

For some small businesses, the POS terminal 116 and the scanner 122 can be combined into and replaced by a cell phone or a communication device with a camera.

The QR code 120 is actually an imaged data packet. The data packet, which includes a payment token, can also be transmitted from the payment account system 102 to the merchant invoicing system 104 by wireless signals, such as NFC (near-field communication), since there are a lot of mobile phones and POS terminals having NFC capabilities.

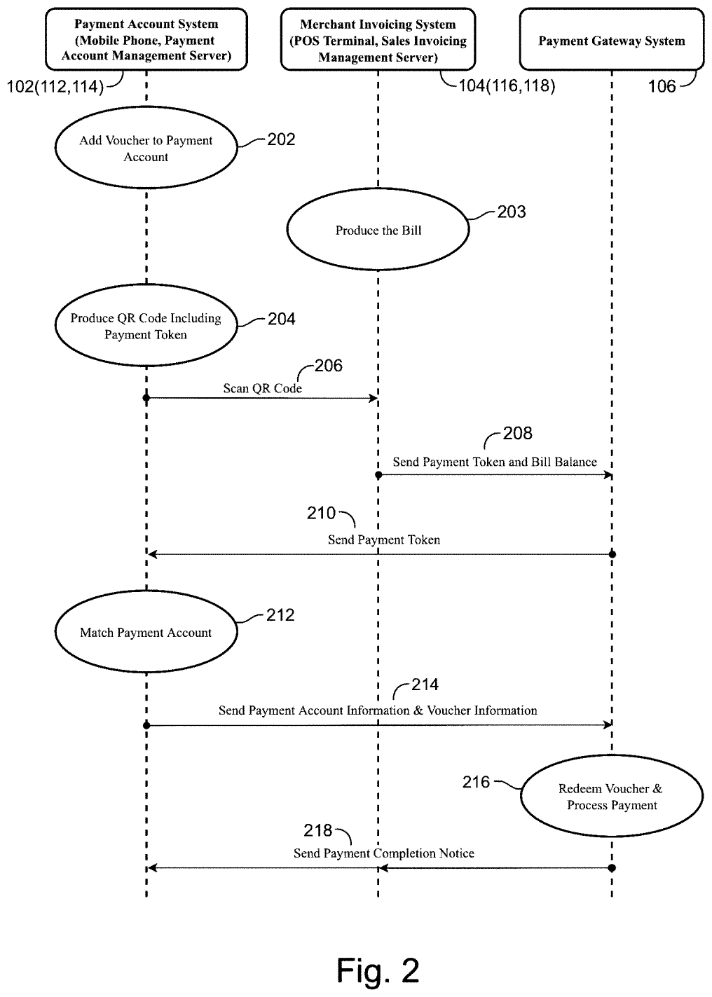

FIG. 2 shows an integrated block flowchart in which the systems and the methods for performing mobile payment with voucher redemption are applied. The integrated block flowchart is similar to the system sequence diagram (SSD), which shows process interactions arranged in time sequence in the field of software engineering. Both of them can depict the processes involved and the sequence of messages exchanged between the processes needed to carry out the functionality.

This kind of diagram specifies and shows the following:
System actors
Messages (methods) invoked by these actors
Return values (if any) associated with previous messages

In FIG. 2, three system actors are shown on the top. The methods are also indicated step by step along the parallel vertical dashed line.

Before using the arrangement, the consumer needs to have a registered payment account saved in the payment account system 102, and more specifically, have a mobile phone 112 and a mobile app relative to the payment account management server (PAMS) 114 to initiate the payment and voucher redemption. If a customer is a member of Amazon, his payment account information, like credit card information, should be stored in amazon's PAMS.

At step 202, the consumer adds the voucher information to the payment account before launching the mobile phone payment and voucher redemption. If it is a restaurant voucher, the voucher information may include the restaurant's ID, the cash value bearing, and the expiration date. It may also only be a string of voucher code that the payment gateway system 106 can recognize according to previous arrangements.

At step 204, the consumer uses the mobile app to produce a QR code, which includes the payment token (session ID). The payment token mentioned here is actually a session identifier that is a piece of data used in network communication to identify a session, a series of related message exchanges.

At step 206, the QR code is scanned into the merchant invoicing system 104 during the checkout period, not necessarily after the bill is produced in the merchant invoicing system 104 at step 203, as shown in the diagram. The QR code can be scanned into the merchant invoicing system 104 before the bill is produced.

At step 208, the SIMS 118 sends the payment token and bill balance to the payment gateway system 106, where the payment token is used to identify which PAMS it is issued by. The payment token may include an identification code to show which payment account system it is issued by. Then the payment token is transferred to the relevant PAMS 114 at step 210.

According to the unique payment token, the PAMS 114 matches and finds the initiating payment account at step 212, then sends the detailed payment account information, such as credit card information and voucher information, to the payment gateway system 106 at step 214. In some cases, the credit card information can be replaced by another token authorized by a Token Service Provider (TSP). This token is different from the payment token, which is produced and authorized by a PAMS 114.

After getting the payment account and voucher information, at step 216, the payment gateway 106 processes the payment after redeeming the voucher and finalizing the invoice balance. For payment processing, payment gateway system 106 needs to forward the transaction information to the payment processor used by the merchant's acquiring bank following the PCI-compliance regulations and procedures, which are not illustrated in detail in the description of preferred embodiments.

Finally, at step 218, the payment gateway system 106 sends the payment completion notice to SIMS 118 and PAMS 114, respectively. Then the transaction is finished by using the inventive systems and methods of mobile payment with voucher redemption.

By utilizing the inventive arrangement, the consumer can use some mobile apps, such as Chase, Groupon, Amazon, and Walmart apps, to pay at any merchants' registers that adopt the inventive systems and methods with or without redeeming vouchers.

We can see in FIG. 2 that the voucher redemption is technically processed and fulfilled at the payment gateway system 106 instead of the merchant invoicing system 104, so the merchants don't need to bloat and complicate their POS systems to redeem the vouchers.

FIG. 3 shows a functional block diagram depicting a payment gateway system configured pursuant to some embodiments.

A typical payment gateway system does not include voucher redemption and payment token management modules. To accomplish the mobile payment with voucher redemption, the invention arranges the additions of payment token management module 302 and voucher redemption management module 304 into the payment gateway system 106.

At step 3A, a merchant invoicing system 104 sends the payment token and bill balance to the payment gateway system 106, where the two categories of information are respectively filtered into the corresponding modules, which are the payment token management module 302 and the bill management module 306. Two categories of information are managed respectively in the two modules.

In the payment token management module 302, the payment token is used to identify which payment account system 102 it is issued by. Then the payment token is transferred to the corresponding payment account system 102 at step 3B.

According to the unique payment token, the payment account system 102 matches and finds the initiating payment account, then sends the detailed payment account information (such as credit card information) and the voucher information to the payment gateway system 106. The voucher information and payment account information are respectively filtered into the voucher redemption management module 304 and bill management module 306 in the payment gateway system 106 at step 3C.

In the voucher redemption management module 304, the input voucher information is verified. If the voucher is valid, at step 3D, the confirmed voucher cash value will be sent to bill management module 306, where the voucher value is deducted from the original bill balance. At step 3E, the payment account information and the transaction information, including the final bill balance, are transferred to the payment processor or acquiring bank 308 for the processing of the payment. Then at step 3F, the payment processor 308 sends the payment confirmation to the bill management module 306.

Finally, at step 3G, the bill management module 306 sends the payment completion notice to the merchant invoicing system 104 and payment account system 102 respectively.

A typical payment gateway facilitates a payment transaction by the transfer of information between a payment portal (merchant invoicing system) and the front-end processor or acquiring bank. In FIG. 3, we can see the inventive payment gateway system 106 is the medium to transfer information among payment account system 102, merchants invoicing system 104, and payment processor 308, which cannot exchange information directly with each other by themselves.

This sophisticated and deliberate system architecture and information flows are made to secure systems and protect against fraud. Additionally, the inventive arrangement subtly accomplishes that a third-party mobile wallet can conveniently pay at any store where the inventive methods and systems are adopted, e.g., Amazon mobile wallet, if any, can be used to pay for in-store purchases at Walmart. Without the invention, the customer can only use the merchant's or the payment processor's app, instead of the third-party mobile wallet apps, to make a payment. It is known that a customer can use his PayPal app to pay at CVS stores because PayPal is its payment gateway service provider or payment processor. In this case, the PayPal app cannot be defined as a third-party mobile wallet. Using the inventive infrastructure, even if some mobile wallets are independent of CVS and its payment gateway service provider, CVS's payment gateway system can directly exchange information with third-party payment account systems, such as Amazon, Walmart, and Groupon wallet, if any. The new features and functionalities of the payment gateway system fulfill the third-party mobile payments with or without voucher redemptions.

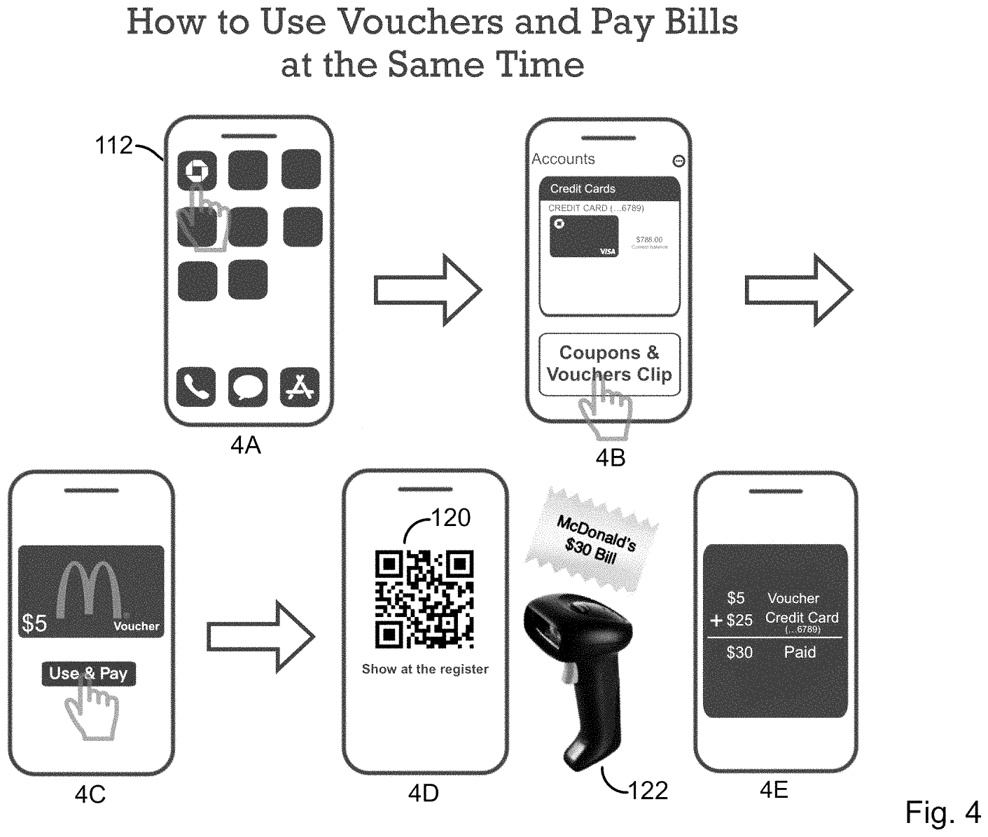

Reference is now made to FIG. 4, which depicts a number of illustrative user interfaces that may be presented to a user operating a mobile device (such as the mobile device 112 of FIG. 1) on a display screen of the device so that the customer can conduct payment transactions and voucher redemptions using features of embodiments of the present invention.

They are interface flow diagrams illustrating how a customer uses his mobile phone to redeem a voucher and pay a bill simultaneously at a McDonald's store. The fast-food restaurant businesses seriously care about checking efficiency, especially for driving-through orders. The adoption of this invention at these stores will greatly improve the checking experience of both customers and cashiers.

At step 4A, the customer opens the mobile wallet app by clicking on the icon on the display of the mobile phone 112. The interface at step 4B shows some of the payment account information and the vouchers clip icon. In this case, some vouchers are already added to the voucher clip. After the customer clicks on the voucher clip icon, the McDonald's voucher information is displayed at step 4C. The customer decides to use the voucher, then clicks the “Use and Pay” button. Sequentially, at step 4D, a QR code 120 is shown on the display of the phone device. (The QR code in the FIGure is only a sample, not a real transaction QR code.) This QR code 120 includes a payment token which the scanner 122 of McDonald's POS terminal can read into the merchant invoicing system. Finally, after the transaction payment processing is executed by the payment gateway and payment processor, the voucher redemption and payment confirmation notice are sent back and displayed on the mobile device at step 4E.

Although the present invention has been described in conjunction with specific exemplary embodiments, it should be acknowledged that various changes, substitutions, and alterations apparent to those skilled in the art can be made to the disclosed embodiment without departing from the spirit and scope of the invention as forth in the appended claims.

For example, the QR code utilized in the disclosure is one of the ways to transfer relative information. Any patterned image that can be read into data by a scanner may be an alternative to replace the QR code. Near-field communication (NFC) and other wireless signals can also transmit information for the inventive systems and methods. The substitution of the data transmission of the QR code won't invalidate the novelty and creativity of the invention.

It is intended that the appended claims cover all such additions, modifications, and rearrangements.

What is claimed is:

1. A method for operating a payment account system to execute mobile payment, involving a payment gateway system and a merchant invoicing system, the method comprising:
Producing a data packet, including a payment token, associated with a payment account;
Transmitting, to said merchant invoicing system, said data packet including said payment token;
Receiving, from said payment gateway system, information including said payment token;
Matching said payment account according to said payment token;
Transmitting, to said payment gateway system, information including said payment account information; and
Receiving, from said payment gateway system, information including a payment completion notice.

2. The method of claim 1, wherein at least one piece of voucher information is added to said payment account;
Correspondingly, the method comprising:
Transmitting, to said payment gateway system, information including said payment account information and voucher information, instead of transmitting, to said payment gateway system, information including said payment account information.

3. The method of claim 1, wherein said data packet is shown as an encoded image including at least one of (a) a barcode, (b) a QR code, and (c) an image pattern, the implicit information in said encoded image including said payment token is transmitted to said merchant invoicing system by scanning said encoded image using a scanner connected to said merchant invoicing system.

4. The method of claim 1, wherein said data packet is transmitted to said merchant invoicing system by a wireless signal.

5. The method of claim 2, wherein said voucher information is gift card information, which is redeemed at said payment gateway system.

6. The method of claim 1, wherein said payment account system is divided into some subsystems including a mobile phone and a payment account management server; thereby, said information is exchanged between said subsystems and said merchant invoicing system or said payment gateway system.

7. A payment account system, operable to executing mobile payment involving a payment gateway system and a merchant invoicing system, the payment account system comprising:
a mobile phone;
a payment account management server;
and software programs, wherein the programs are configured to be executed by the mobile phone and payment account management server, the programs including:
Instructions for producing a data packet, including a payment token, associated with a payment account;
Instructions for transmitting, to said merchant invoicing system, said data packet including said payment token;
Instructions for receiving, from said payment gateway system, information including said payment token;
Instructions for matching said payment account according to said payment token;
Instructions for transmitting, to said payment gateway system, information including said payment account information; and
Instructions for receiving, from said payment gateway system, information including a payment completion notice.

8. A payment account system of claim 7, wherein at least one piece of voucher information is added to said payment account;
Correspondingly, the programs including:
Instructions for transmitting, to said payment gateway system, information including said payment account information and voucher information, instead of instructions for transmitting, to said payment gateway system, information including said payment account information.

9. A payment account system of claims 7, wherein said data packet is shown as an encoded image including at least one of (a) a barcode, (b) a QR code, and (c) an image pattern, the implicit information in said encoded image including said payment token is transmitted to said merchant invoicing system by scanning said encoded image using a scanner connected to said merchant invoicing system.

10. The payment account system of claim 7, wherein said data packet is transmitted to said merchant invoicing system by a wireless signal.

11. The payment account system of claim 8, wherein said voucher information is gift card information, which is redeemed at said payment gateway system.

12. The payment account system of claim 7, wherein said payment account system is divided into some subsystems including a mobile phone and a payment account management server; thereby, said information is exchanged between said subsystems and said merchant invoicing system or said payment gateway system.

13. A method for operating a payment gateway system to execute mobile payments, involving a payment account system and a merchant invoicing system, the method comprising:
Receiving, from said merchant invoicing system, information including a bill balance and a payment token associated with a payment account;
Identifying said payment account system according to said payment token;
Transmitting, to said payment account system, information including said payment token;
Receiving, from said payment account system, information including said payment account information;
Processing a payment according to information including said payment account information and said bill balance; and
Transmitting, to said payment account system and said merchant invoicing system, information including a payment completion notice.

14. A method of claim 13, wherein at least one piece of voucher information is added to said payment account; Correspondingly, the method comprising:
Receiving, from said payment account system, information including said payment account information and at least one piece of voucher information, instead of receiving, from said payment account system, information including said payment account information;
Redeeming at least one piece of voucher information and processing a payment of the rest of said bill according to information including said payment account information, instead of processing a payment according to information including said payment account information and said bill balance.

15. A method of claim 14, wherein said voucher information is gift card information.

16. A Method of claim 14, wherein said payment gateway system is divided into some subsystems including a payment token management module, a voucher redemption management module, and a bill management module; thereby, said information is exchanged between said modules and said merchant invoicing system or said payment account system.

17. A payment gateway system, operable to executing mobile payments, involving a merchant invoicing system and a payment account system, the payment gateway system comprising:
a communication port;
a processor;
a memory;
and software programs, wherein the programs are stored in the memory and configured to be executed by the processor, the programs including:
Instructions for receiving, from said merchant invoicing system, information including a payment token and a bill balance and a payment token associated with a payment account;
Instructions for identifying said payment account system according to said payment token;
Instructions for transmitting, to said payment account system, information including said payment token;
Instructions for receiving, from said payment account system, information including said payment account information;
Instructions for processing a payment according to information including said payment account information and said bill balance; and
Instructions for transmitting, to said payment account system and said merchant invoicing system, information including a payment completion notice.

18. A payment gateway system of claim 17, wherein at least one piece of voucher information is added to said payment account; Correspondingly, the programs including:
Instructions for receiving, from said payment account system, information including said payment account information and at least one piece of voucher information, instead of instructions for receiving, from said payment account system, information including said payment account information;
Instructions for redeeming at least one piece of voucher information and processing a payment of the rest of said bill according to information including said payment account information, instead of instructions for processing a payment according to information including said payment account information and said bill balance.

19. A payment gateway system of claim 18, wherein said voucher information is gift card information.

20. A payment gateway system of claim 18, wherein said payment gateway system is divided into some subsystems, including a payment token management module, a voucher redemption management module, and a bill management module; thereby, said information is exchanged between said modules and said merchant invoicing system or said payment account system.
